(19) United States
(12) Patent Application Publication
(10) Pub. No.: US 2007/0097685 A1
(43) Pub. Date: May 3, 2007

(54) Decorative lighting apparatus and method

(75) Inventor: Fu Gan, Shenzhen City (CN)

Correspondence Address: CHARLES E. BAXLEY, ESQUIRE, SUITE 309, 90 JOHN STREET, NEW YORK, NY, 10038, US

(73) Assignee: Shenzhen City Longgang District Henggang Jinfushun Plastic Pipe Factory

(21) Appl. No.: 11/297,606

(22) Filed: Dec. 8, 2005

(30) Foreign Application Priority Data
Nov. 3, 2005 (CN) 200510100849.7

(51) Int. Cl. F21S 6/00; F21V 33/00

(52) U.S. Cl. 362/252; 362/123

(57) ABSTRACT

The present invention provides a decorative lighting apparatus and method for fabricating the same. The decorative lighting apparatus comprises a framework with three-dimensional structure, a plurality of strings of illuminations mounted in a house formed by said framework and a wrap put on said framework. The method for fabricating the decorative lighting apparatus comprises steps as following: (1) disposing and fastening metal wire or rod with insulating and fireproof outer layer to form a framework with three-dimensional structure and desired outline; (2) mounting a plurality of strings of illuminations in a house formed by said framework; (3) knitting fiberglass into a wrap, which has a corresponding shape and size of the outline of said framework; (4) putting said wrap on said framework. The decorative lighting apparatus of the present invention is fireproof and so it is safe.

### CROSS REFERENCES TO RELATED APPLICATIONS

This application is related to and claims priority to Chinese Application No. 200510100849.7, filed Nov. 3, 2005, incorporated herein by reference in its entirely.

### BACKGROUND OF THE PRESENT INVENTION

1. Field of Invention

The present invention relates to a decorative lighting apparatus, and more particularly to a decorative lighting apparatus, and to methods for fabricating the same.

2. Description of Related Arts

All over the world, there are varieties of festivals with certain history or religion meanings every year. In festivals, all kinds of decorative lighting apparatuses capable of conveying an aesthetic feeling to people are employed to promote atmosphere. These decorative lighting apparatuses include decorative lighting apparatus with outline of snowman or Santa Claus in west or festive lantern in China. In the same time, there is usually firework and needfire. Fires that cause damage to people and objects are frequently occur in festivals. Some of the fires are caused by decorative lighting apparatuses, which are made of inflammable material. There are known lighting apparatuses, which are wrapped a fireproof layer. But the fireproof layer is wrapped manually. Movement facilitates the fireproof layer loosing. What's more, the process to wrap cost a lot of manpower.

### SUMMARY OF THE PRESENT INVENTION

To overcome the drawback mentioned above, a primary objective of the present invention is to provide a decorative lighting apparatus, which is fireproof.

To achieve the objective described above, the decorative lighting apparatus according to the present invention comprises a framework with three-dimensional structure, a plurality of strings of illuminations mounted in a house formed by the framework and a wrap put on the framework.

In one embodiment, the strings of illuminations are mounted on a inner wall of the house formed by the framework.

In another embodiment, the framework is made of metal material with insulating and fireproof outer layer.

In another embodiment, the wrap is knitted of fiberglass and has a corresponding shape and size of the outline of the framework.

In another embodiment, the outline of the framework is snowman-shaped.

In another embodiment, the outline of the framework is Santa Claus-shaped.

In other embodiments, the outline of the framework is shaped any shape of a deer, a Christmas tree, a sled, a present, a polar bear, a snowflake and a combined thereof.

The method for fabricating a decorative lighting apparatus according to the present invention, comprises:

disposing and fastening metal wire or rod with insulating and fireproof outer layer to form a framework with three-dimensional structure and desired outline;

mounting a plurality of strings of illuminations in a house formed by the framework;

knitting fiberglass into a wrap, which has a corresponding shape and size of the outline of the framework; and

putting the wrap on said framework.

In one embodiment, a common knitting machine is employed to knit the wrap.

In another embodiment, a programmable controlled knitting machine is employed to knit the wrap.

Accordingly, the decorative lighting apparatus and method for fabricating the same of the present invention has the following advantages:
1. The decorative lighting apparatus is fireproof and so it is safety.
2. More shape can be selected.
3. Knitting machine is employed to knitting the wrap so it saves manpower to fabricating the decorative lighting apparatus.

### BRIEF DESCRIPTION OF THE DRAWINGS

FIG. 1 is a perspective view showing a decorative lighting apparatus of a preferred embodiment according to the present invention, wherein the outline of the framework is snowman-shaped;

FIG. 2 is a perspective view showing the framework of the decorative lighting apparatus in FIG. 1.

### DETAILED DESCRIPTION OF THE PREFERRED EMBODIMENTS

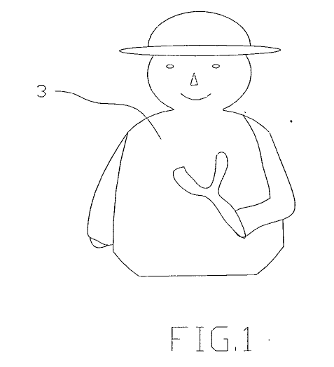

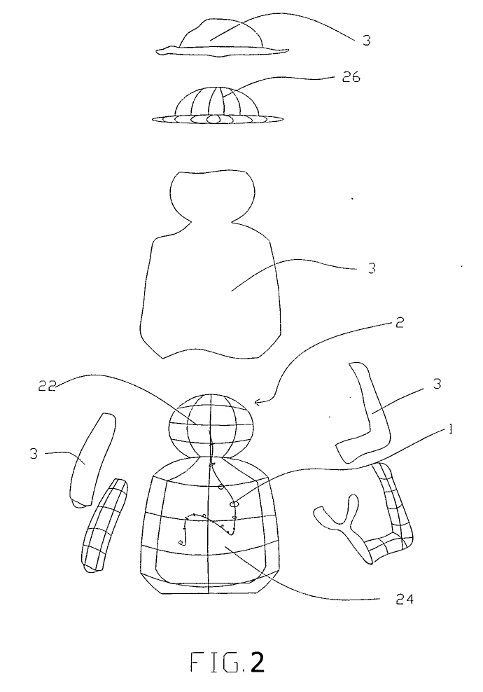

In one preferred embodiment, referring to FIG. 1 and FIG. 2, a decorative lighting apparatus according to the present invention comprises a plurality of strings 1 of illuminations, a framework 2 and a wrap 3.

The framework 2 has three-dimensional structure and forms a hollow house enveloped therein. The framework 2 is made of iron wire with insulating and fireproof coating layer. The iron wire used is disposed longitudinally and latitudinally to form the outline of the framework 2, which is snowman-shaped. The framework 2 includes head section 22, body section 24 and hat section 26.

The strings 1 of illuminations are mounted in the house formed by the framework 1. The strings 1 of illuminations can also be mounted on the inner wall of the house formed by the framework 2. The strings 1 of illuminations are variety color illumination unit connected with electrical wire and powered by DC or AC.

The wrap 3 is knitted of fiberglass and has corresponding shape and size of the outline of the framework 2 and is put on the framework 1.

The steps to fabricate the decorative lighting apparatus is as following:
(1) to fabricate the framework 1, bending the iron wire according to requirement and disposing and fastening it to form the head section 22, the body section 24 and the hat section 26;
(2) mounting the strings 1 of illuminations in the house formed by the framework 2 or on the inner wall of the house formed by the framework 1;
(3) adjusting a knitting machine according the outline of the framework 1 to knit fiberglass into the wrap 3; and
(4) putting the wrap 3 on the framework 1.

As an example, a knitting machine CK-35 made by Brother International Ltd. is employed. The knitting machine has automatic yarn switching equipment. A motor controlled by a computer is employed to carry out switching between yarn inlets to knit desired product with variety patterns. The knitting machine has bulk memory and input card system that facilitate it to change technical data. In knitting, the wide to be knitted can be changed according to desired product.

As known, fiberglass is fireproof. So the wrap knitted of fiberglass is fireproof too. There are through holes among fiberglass of the wrap, from which the light given by the illuminations penetrate. So the outline of the snowman is shown in night to promote atmosphere of festival.

Therefore, compare to known decorative lighting apparatus having shell made of plastic, wool, wood and/or bamboo, the decorative lighting apparatus of the present invention is fireproof and so it is safer. On the other hand, the outline of framework can be facilely changed to accommodate different requirement. What's more, knitting machine is employed to knit the wrap. So it saves manpower and cost to fabricate the decorative lighting apparatus.

In an alternative embodiment, the outline of framework is Santa Claus-shaped. And the wrap has corresponding shape and size of the outline of the framework. In fabricating, as the shape is more complex, a knitting machine KH970 made by Brother International Ltd. is employed.

Alternatively, the outline of said framework can be shaped any shape of a deer, a Christmas tree, a sled, a present, a polar bear, a snowflake and the like, or a combined thereof.

As described with numerous exemplary embodiments, a decorative lighting apparatus and a method for fabricate the same are proposed. However, for those skilled in this field, these exemplary embodiments can be easily adapted and modified to suit additional applications without departing from the spirit and scope of this invention. Thus it is to be understood that the present disclosure has been made by way of example only and that numerous changes in the detailed construction and the combination and arrangement of parts may be resorted to without departing from the spirit and scope of the invention as hereinafter claimed.

What is claimed is:

1. A decorative lighting apparatus, comprising:
a framework with three-dimensional structure;
a plurality of strings of illuminations mounted in a house formed by said framework; and
a wrap put on said framework.

2. The decorative lighting apparatus, as recited in claim 1, wherein said plurality of strings of illuminations are mounted on a inner wall of the house formed by said framework.

3. The decorative lighting apparatus, as recited in claim 1, wherein said framework is made of metal material with insulating and fireproof outer layer.

4. The decorative lighting apparatus, as recited in claim 1, wherein said wrap is knitted of fiberglass and has a corresponding shape and size of the outline of said framework.

5. The decorative lighting apparatus, as recited in claim 2 wherein said wrap is knitted of fiberglass and has a corresponding shape and size of the outline of said framework.

6. The decorative lighting apparatus as recited in claim 3 wherein said wrap is knitted of fiberglass and has a corresponding shape and size of the outline of said framework.

7. The decorative lighting apparatus, as recited in claim 1, wherein the outline of said framework is snowman-shaped.

8. The decorative lighting apparatus, as recited in claim 2, wherein the outline of said framework is snowman-shaped.

9. The decorative lighting apparatus, as recited in claim 3, wherein the outline of said framework is snowman-shaped.

10. The decorative lighting apparatus, as recited in claim 1, wherein the outline of said framework is Santa Claus-shaped.

11. The decorative lighting apparatus, as recited in claim 2, wherein the outline of said framework is Santa Claus-shaped.

12. The decorative lighting apparatus, as recited in claim 3, wherein the outline of said framework is Santa Claus-shaped.

13. The decorative lighting apparatus, as recited in claim 1, wherein the outline of said framework is shaped any shape of a deer, a Christmas tree, a sled, a present, a polar bear, a snowflake and a combined thereof.

14. The decorative lighting apparatus, as recited in claim 2, wherein the outline of said framework is shaped any shape of a deer, a Christmas tree, a sled, a present, a polar bear, a snowflake and a combined thereof.

15. The decorative lighting apparatus, as recited in claim 3, wherein the outline of said framework is shaped any shape of a deer, a Christmas tree, a sled, a present, a polar bear, a snowflake and a combined thereof.

16. A method for fabricating a decorative lighting apparatus, comprising:
disposing and fastening metal wire or rod with insulating and fireproof outer layer to form a framework with three-dimensional structure and desired outline;
mounting a plurality of strings of illuminations in a house formed by said framework;
knitting fiberglass into a wrap, which has a corresponding shape and size of the outline of said framework; and
putting said wrap on said framework.

17. The method for fabricating a decorative lighting apparatus, as recited in claim 16, wherein a common knitting machine is employed to knit said wrap.

18. The method for fabricating a decorative lighting apparatus, as recited in claim 16, wherein a programmable controlled knitting machine is employed to knit said wrap.
